(19) United States
(12) Patent Application Publication
(10) Pub. No.: US 2020/0094938 A1
(43) Pub. Date: Mar. 26, 2020

(54) AIRCRAFT SYSTEM WITH INTERCHANGEABLE DRIVE MODULE UNITS

(71) Applicant: QUANTUM-SYSTEMS GMBH, Gilching (DE)

(72) Inventor: Florian SEIBEL, Gilching (DE)

(21) Appl. No.: 16/577,724

(22) Filed: Sep. 20, 2019

(30) Foreign Application Priority Data
Sep. 21, 2018 (DE) 10 2018 123 348.5

(51) Int. Cl. B64C 1/16; B64C 29/00; B64C 39/02; B64C 1/26; B64C 9/02

(52) U.S. Cl. CPC B64C 1/16; B64C 2201/20; B64C 39/024; B64C 1/26; B64C 9/02; B64C 2211/00; B64C 2201/02; B64C 2201/042; B64C 2201/108; B64C 2201/126; B64C 2201/127; B64C 2201/122; B64C 2201/123; B64C 2201/165; B64C 29/0033

(57) ABSTRACT

An aircraft system includes an aircraft fuselage having at least one coupling point that is configured to connect various mutually exchangeable drive module units detachably and load-transmittingly to the aircraft fuselage. The aircraft system further includes at least one first drive module unit that is detachably, load-transmittingly and with another drive module unit exchangeably attachable to the at least one coupling point to form a first aircraft comprising the aircraft fuselage and the first drive module unit and at least one second drive module unit that is detachably, load-transmittingly and with another drive module unit exchangeably attachable to the at least one coupling point to form a second aircraft comprising the aircraft fuselage and the second drive module unit. In some embodiments, the first aircraft is a rotary wing aircraft and the second aircraft is a fixed-wing aircraft or a convertiplane.

### CROSS-REFERENCE TO RELATED APPLICATION

This application claims priority to German Application No. 10 2018 123 348.5 filed on Sep. 21, 2018.

### TECHNICAL FIELD

This invention concerns an aircraft system that includes an aircraft fuselage and interchangable drive module units.

### BACKGROUND

In the field of unmanned aircraft, drones and/or unmanned aircraft, different concepts are known which concern the take-off and landing of such aircraft. For example, drones are known which are launched by means of a catapult and are designed in the form of a conventional wing airplane with a rigid wing, also known as a fixed-wing aircraft. The achievable possible flight times of these aircraft are quite high due to their system design, as these aircraft have a high aerodynamic quality. Preparations for take-off, however, are extensive due to the required infrastructure in the form of a catapult or runway. Also for the landing precautions are necessary here, since these aircraft need either a runway, or are landed in a net or at a parachute.

Also known are drones, which operate as rotary wing aircraft. The corresponding achievable flight times are relatively short compared to airplanes or fixed-wing aircraft due to the high energy input required by the system design. However, the preparations for take-off and landing are completed more quickly, so that these aircraft can be used more quickly and, in particular, do not require the installation of a catapult or a runway, nor the installation of receiving nets.

An example of such an aircraft based on the rotating wing concept is known from the WO 2009/115300 A1, for example, where this aircraft is suitable for carrying a forward facing surveillance camera.

Another approach is the combination of the rotating wing concept and the fixed-wing concept, so that on the one hand a vertical take-off and landing (VTOL) can be achieved, and on the other hand a horizontal flight can be carried out due to the aerodynamically pronounced fixed-wing. An aircraft designed in this way is also referred to as a “convertiplane”. A characteristic feature of such aircraft is that they can take off like a rotary wing aircraft in a hover flight and then, via a transition flight operation, change to a horizontal flight that is comparable to a flight mode of a fixed-wing aircraft. For this purpose, such aircraft are usually equipped with a drive in which the horizontal and vertical thrust forces acting on the aircraft can be variably adjusted. For this purpose, the aircraft can have a tilting wing rotor or a swivel rotor drive, for example.

This concept has long been used in manned aircraft, with the Bell-Boeing V-22 (“Osprey”) being a particularly outstanding example.

In the field of unmanned aerial vehicles, for example, an aircraft known from US 2011/0001020 A1 which, on the basis of a so-called Quad-Tilt Rotor aircraft (QTR), discloses a corresponding combination of a rotary wing aircraft and a fixed-wing aircraft. The four rotors according to this concept are arranged such that two main rotors are arranged at the outermost ends of the main wing and two significantly smaller rotors are arranged at the outermost ends of the horizontal stabilizers. This concept makes it possible to combine the favorable characteristics of the rotary wing aircraft with those of the fixed-wing aircraft.

Unmanned aircraft and in particular so-called MAV (Micro Aerial Vehicles—small unmanned aircraft), which can be used for surveillance and reconnaissance purposes, are of great use in both civil and military applications.

For example, such unmanned aircraft can be used in civilian applications to monitor and control gas and oil pipelines in order to detect leaks at an early stage and estimate the maintenance requirements of the pipeline. Further civilian application scenarios include, for example, the security of port facilities or in large-scale industry, the monitoring and maintenance of offshore facilities such as wind farms, drilling and production platforms, the monitoring of transmission lines, tasks in the field of environmental protection and nature conservation, the monitoring of forest stands and forest conditions, investigations into the extent of damage following natural disasters, surveillance and investigations in the field of species protection to identify animal populations, monitoring compliance with fishing quotas, the protection of historical monuments and the inspection of the structure of buildings, the monitoring of major events such as regattas, rallies and other sporting events, use in the field of aerial photography and aerial filming, and mapping.

In the scientific field, such unmanned aircraft can continue to be used, for example, for exploring oil deposits and other geological formations, for researching volcanoes and predicting volcanic eruptions, or for mapping archaeological sites. In the field of agriculture such unmanned aerial vehicles can be used to monitor agricultural areas, which can be of great importance in the field of so-called “precision farming” in order to be able to plan and monitor the corresponding use of machines. In addition, the growth of the respective crop on the field to be monitored can also be measured, for example using infrared cameras. In this way it is also possible to check the overall condition of a crop and thus determine the optimum harvest time. Furthermore, any pest infestation that may occur can be detected in time so that appropriate countermeasures can be initiated. Monitoring from the air can also be used to determine different soil conditions within a field area, so that the input of fertilizers can be planned and optimized for specific soil sections.

Further deployment scenarios concern the deployment in the area of responsibility of the authorities and organisations with security tasks (BOS), such as SAR (Search and Rescue), disaster control, damage assessment in the event of natural disasters (storms, floods, snow and mud avalanches, large-scale and area fires, earthquakes, tsunamis, volcanic activity), damage assessment in the event of disasters of a technical-biological nature (e.g. B. nuclear reactor accidents, chemical or oil accidents), support of operational coordination through live images, monitoring of major events and protests/demonstrations, traffic monitoring, as well as communication relays to extend the range.

In the military sector, unmanned aircraft are used for reconnaissance, to monitor objects such as base camps, to secure borders, to secure convoys, can be used in disaster control and can be used for SAR (Search and Rescue) missions. Other military applications include CSAR (Combat Search and Rescue), use as communication relays (e.g. to request CSAR forces, to increase range), coordination of material supplies, as escort protection (e.g. convoy protection), for patrol flights and scouting flights, for tactical reconnaissance (e.g. in urban areas or even inside buildings, BDA), for surveillance, target marking, explosive ordnance search (e.g. mine or IED detection, detection of NBC contamination), for electronic warfare, as well as for the use of explosive ordnance (e.g. light guided missiles).

The example applications mentioned above illustrate the broad and multifaceted fields of application of unmanned aircraft. An optimal configuration of the aircraft for the intended use can be different for each application.

### SUMMARY

An aircraft system includes an aircraft fuselage having at least one coupling point that is configured to connect various mutually exchangeable drive module units detachably and load-transmittingly to the aircraft fuselage. The aircraft system further includes at least one first drive module unit that is detachably, load-transmittingly and with another drive module unit exchangeably attachable to the at least one coupling point to form a first aircraft comprising the aircraft fuselage and the first drive module unit and at least one second drive module unit that is detachably, load-transmittingly and with another drive module unit exchangeably attachable to the at least one coupling point to form a second aircraft comprising the aircraft fuselage and the second drive module unit. In some embodiments, the first aircraft is a rotary wing aircraft and the second aircraft is a fixed-wing aircraft or a convertiplane.

### SHORT DESCRIPTION OF THE FIGURES

Embodiments and aspects of the present invention are explained in more detail in the following description of the figures. It is shown schematically:

FIG. 1 illustrates top view of a first aircraft of an aircraft system according to the present invention;

FIG. 2 illustrates a side view of the first aircraft shown in FIG. 1;

FIG. 3 illustrates a top view of a second aircraft of the aircraft system according to the present invention in a first mode of operation;

FIG. 4 illustrates a side view of the second aircraft shown in FIG. 3 in the first operating mode;

FIG. 5 illustrates a top view of the second aircraft of the aircraft system according to the present invention in a second mode of operation; and

FIG. 6 illustrates a side view of the second aircraft shown in FIG. 5 in the second operating mode.

### DESCRIPTION OF EMBODIMENTS

One of the tasks of the present disclosure is to specify an aircraft system, for example an unmanned aircraft system or a drone system, which provides an aircraft that can be used flexibly and configured with reduced effort. Furthermore, an aircraft fuselage and a drive module unit for such an aircraft shall be specified.

Accordingly, an aircraft system is proposed, for example an unmanned aircraft system and/or a drone system, comprising an aircraft fuselage with at least one coupling point. The at least one coupling point is configured to attach various interchangeable drive module units to the aircraft fuselage in a detachable and load-transmitting manner. The aircraft system further comprises at least one first drive module unit, which is detachably, load-transmittingly and exchangeably with another drive module unit attachable to the at least one coupling point of the aircraft fuselage to form a first aircraft comprising the aircraft fuselage and the first drive module unit, and at least one second drive module unit which is detachably, load-transmittingly and exchangeably with another drive module unit attachable to the at least one coupling point in order to form a second aircraft comprising the aircraft fuselage and the second drive module unit. The first aircraft and the second aircraft are different aircraft types.

Herein, “aircraft types” are understood to mean aircraft or aircraft concepts which differ in terms of their flight characteristics, in particular their optimum operating points, and their lift and propulsion generation in the various flight phases. Regarding aircraft types, generally, a distinction can be made between fixed-wing aircraft, rotary wing aircraft and VTOL fixed-wing aircraft.

A “fixed-wing aircraft”, also commonly referred to as an airplane or fixed-wing aircraft, is an aircraft or aerial vehicle in which the dynamic lift required for flight operation is generated by rigid wings, i.e. non-rotating lift surfaces, with a flow around them in flight. Such aircraft usually require a runway to take off and land safely, as a sufficiently high lift for flight operations is only generated above a minimum speed.

The term “rotary wing aircraft”, generally also referred to as helicopters, is used to describe aircraft or aerial vehicles in which around a vertical axis of the aircraft rotating lift surfaces, so-called rotors, generate the lift required for flight operations.

The term “VTOL fixed-wing aircraft”, also known as vertical take-off and landing aircraft or convertiplane, refers to fixed-wing aircraft with the ability to take off and land vertically and without a runway. Typically, such aircraft are operated in hover mode for take-off and landing. Similar to rotary wing aircraft, the lift can be generated by lift surfaces or rotors rotating around a vertical axis of the aircraft. The aircraft is then converted into a horizontal flight in which the lift is generated by rigid wings as the horizontal speed of the aircraft increases.

One of the solutions proposed here proposes an aircraft system, in particular in the form of a modular construction kit, in which drive module units can be mounted on the aircraft fuselage that are exchangeable and distinguished from each other in order to be able to provide optimally configured aircraft for different missions. In other words, the aircraft system ensures that an aircraft to be formed by the aircraft fuselage and a drive module unit can be easily configured and thus adapted to different operational requirements. For this purpose, the present solution provides a standardized interface in the form of the coupling point, which establishes a structural connection between the aircraft fuselage and the drive module unit to be coupled to it. In this way, both, structurally and functionally distinct module units can be attached to the aircraft fuselage to provide different types or variety of aircraft.

Further it was also recognized herein that the aircraft fuselage is usually a particularly cost-intensive component for unmanned aircraft. This can be attributed in particular to the electronic components it contains, such as contained control units, navigation units, stabilization units, communication units and electrical energy storage units. In the proposed aircraft system, a single aircraft fuselage can be used to form the different aircraft. It is therefore not necessary to use separate aircraft fuselages for the different aircraft. In other words, the proposed solution allows the same aircraft fuselage to be used as a standard component or platform for the different aircraft. Therefore a flexible and cost-optimized aircraft system is provided.

Due to the modular design, a small packing size can be achieved, so that the aircraft can be easily transported to its respective site of operation. Furthermore, it is easy to replace any damaged modules in this way.

As described above, different interchangeable drive module units may be attached to the aircraft fuselage to provide aircraft of different aircraft types. The aircraft system is designed such that the first aircraft and the second aircraft are different aircraft types selected from the group comprising fixed-wing aircraft, rotary wing aircraft and convertiplane.

To provide the different aircraft, in particular the different aircraft types, the first and second drive module units can be built differently. The basic structure of the drive module units can provide a carrier structure with an additional coupling point which is complementary to the at least one coupling point of the aircraft fuselage and can thus be mechanically coupled. Furthermore, at least one drive unit of the drive module unit can be attached to the carrier structure so that the carrier structure holds and fixes the drive unit relative to the aircraft fuselage in the state of the drive module unit mounted on the aircraft fuselage. The carrier structure can, for example, be in the form of a carrier arm or boom.

The different drive module units can include different drive units and a different number of drive units. A drive unit usually comprises at least one motor, in particular an electrically driven motor or an internal combustion engine, which drives a rotor coupled thereto in a torque-transmitting manner for generating thrust. The rotor, when coupled to the aircraft fuselage, can be adjustable relative to the aircraft fuselage, in particular pivotable, to adjust a direction of thrust relative to the aircraft. Such drive units can be used in particular for the provision of convertiplanes, in particular with VTOL characteristics.

The use of an electric drive is advantageous for the fast and precise controllability of the rotor speeds. External disturbances can thus be effectively controlled. Accordingly, the concept of fast control of thrust or torque by changing rotor speeds does not require adjustable propellers or rotors. Simple rigid propellers, which are foldable for aerodynamic reasons, allow a particularly simple and light construction of the aircraft.

Compared to conventional piston engines or turbines, the electric drive is still extremely quiet and emission-free, at least at the point of use. At the same time, brushless electric motors offer extremely high reliability, low complexity and are nearly maintenance-free. In addition, brushless electric motors are very efficient and lightweight and deliver high power and high torque over a wide speed range with small dimensions. In this way, both the total mass of the aircraft and moments of inertia around the center of mass can be kept small. On the other hand, the highly reliable electric motors can be arranged inside an engine nacelle with aerodynamically advantageous dimensions.

In addition, the drive module units may include a wing unit and/or a tail unit. The wing unit and/or the tail unit can form the support structure for the drive unit within the respective drive module units. In particular, the drive module unit may comprise a wing unit and/or a tail unit when it is used to form a fixed-wing aircraft or a convertiplane in the condition installed on the aircraft fuselage.

In the aircraft system, for the configuration of the second aircraft, all coupling points provided on the aircraft fuselage may be connected to drive module units and for the configuration of the first aircraft, at least one coupling point may not be connected to a drive module unit. This makes it possible, for example, to equip all coupling points with drive module units for the configuration of a convertiplane, and only two of the coupling points can be occupied for the configuration of a rotary wing aircraft.

It may be advantageous if the two coupling points for the configuration of the rotary wing aircraft are equipped with drive module units, each of which is equipped with two motors for driving two rotors per drive module unit. For example, a drive module unit with two rotors is then attached to each of the two opposite coupling points where the wings were attached for the configuration of the convertiplane. The coupling point at which the tail unit of the convertiplane was attached is then not occupied. Thereby, with the occupation of each of the two opposite coupling points by the two described drive module units a quadcopter is configured.

In an alternative, starting from a setup as a convertiplane, in which two opposite coupling points are provided for receiving the wings and one coupling point in the rear region of the fuselage is provided for receiving a tail unit, the three coupling points can be used to configure a quadcopter by attaching a respective drive module unit with one rotor to each of the two opposite coupling points and a drive module unit with two rotors to the coupling point provided in the rear region of the fuselage.

For example, the first aircraft formed by the aircraft fuselage and at least one first drive module unit coupled thereto may be a rotary wing aircraft. More precisely, the first aircraft can be a helicopter. For example, a first drive module unit may include a main rotor of the helicopter and a further drive module unit may include a further main rotor or a tail rotor to generate a yaw moment. The rotary wing aircraft can also be configured as a duocopter, a tricopter or a quadrocopter, in which each of the first drive module units forms a rotor to generate the lift. The rotary wing aircraft can also have more than four rotors, for example six or eight rotors. Furthermore, the at least one first drive module unit may comprise a wing unit and/or a tail unit.

Furthermore, the second aircraft, formed by the aircraft fuselage and the at least one second drive module unit coupled thereto, may be a fixed-wing aircraft or a convertiplane. In the case of a second aircraft designed as a fixed-wing aircraft, the at least one second drive module unit may comprise, for example, a rotor for generating a forward thrust. Furthermore, the at least one second drive module unit may comprise a wing unit and/or a tail unit.

In a second aircraft configured as a convertiplane, the at least one second drive module unit may comprise, for example, a rotor pivotable relative to the support structure between a first position and a second position, wherein in the first position the rotor generates lift, in the second position the rotor generates a forward thrust, and in a position between the first and second positions the rotor generates lift and a forward thrust.

The aircraft fuselage may have at least one coupling point. For example, the aircraft fuselage can have exactly one coupling point. Alternatively, the aircraft fuselage may have two or more coupling points, for example three. Furthermore, the aircraft system may comprise a first set of drive module units comprising at least two, for example three or four, first drive module units and/or a second set of drive module units comprising at least two, for example three or four, second drive module units. The aircraft fuselage may be mechanically coupled to any of the drive module units forming the set of drive module units to form the desired aircraft.

The aircraft system may further comprise other module units, in particular drive module units. The other module units can comprise a wing unit and/or a tail unit. For example, the aircraft system may comprise at least one third drive module unit which is detachably, load-transmittingly and interchangeably with another drive module unit attachable to the at least one coupling point to form a third aircraft comprising the aircraft fuselage and the third drive module unit. The third aircraft may be an aircraft of a different type from the first and second aircraft. For example, the aircraft system may include a third set of drive module units comprising at least two, for example three or four, third drive module units.

The design of the aircraft fuselage and drive module unit is further specified below in relation to the proposed aircraft fuselage and drive module unit.

In addition, an aircraft fuselage is proposed for use in the aircraft system described above. The features described in this context with the aircraft system shall be deemed to be correspondingly disclosed to the aircraft fuselage and vice versa.

The aircraft fuselage comprises at least one coupling point which is adapted to detachably and load-transmittingly connect various mutually exchangeable drive module units to the aircraft fuselage, wherein the aircraft fuselage is adapted to form aircraft of different aircraft types depending on the drive module unit to be attached to the coupling point.

The at least one coupling point comprises a mechanical interface for load-transmitting connection of the drive module unit to the aircraft fuselage. The mechanical interface may be configured to create a form-locking and/or frictional connection between the drive module unit and the aircraft fuselage.

In particular, the aircraft fuselage may comprise a first coupling point and a second coupling point arranged along a transverse axis on opposite sides of the aircraft fuselage. In addition, the aircraft fuselage may include a third coupling point located at a rear part of the aircraft fuselage relative to a flight direction.

The aircraft fuselage further comprises a control unit for controlling the drive module unit to be attached to the aircraft fuselage via the coupling point and thus for controlling the aircraft formed by the aircraft fuselage and the drive module units to be attached thereto. Here the at least one coupling point comprises a control interface for transmitting control signals to a drive module unit attached to the aircraft fuselage via the coupling point. The control interface is an electrical interface via which electrical control signals are transmitted.

In a further development, the control unit may be configured to control an aircraft formed by the aircraft fuselage and the at least one drive module unit attached thereto in different operating modes depending on the aircraft type predetermined by the drive module unit. In this way, the control unit can adapt a control of the aircraft to the respective aircraft type. This allows for easy maneuvering of the respective aircraft. The control unit can also perform automatic maneuvers limited to controlling certain aircraft or certain types of aircraft.

Furthermore, at least one of the coupling points can comprise an information interface which is provided for determining information relating to the drive module unit attached to the coupling point, in particular with regard to the type of aircraft specified by the at least one drive module unit. The information obtained in this way can be used to determine the aircraft specified by the drive module unit to be coupled or its aircraft type. Accordingly, the control unit can control the aircraft formed by the aircraft fuselage and the at least one drive module unit attached thereto in different operating modes depending on the information determined via the information interface. In this way, an adaptation or selection of operating modes to be made to the respective aircraft to control at least one drive module unit can be made automatically.

The aircraft fuselage further comprises an electrical energy storage device for supplying the drive module unit to be attached to the aircraft fuselage via the coupling point with electrical energy. For this purpose, the at least one coupling point can comprise an electrical interface via which electrical energy can be supplied to a coupled drive module unit.

In addition, a drive module unit is proposed for use or application in the aircraft system described above. The characteristics described in this context with the aircraft system are considered to be correspondingly disclosed for the drive module unit and vice versa.

The drive module unit comprises at least one further coupling point which is complementary to the at least one coupling interface of the aircraft fuselage and which is adapted to detachably and load-transmittingly connect the drive module unit to the aircraft fuselage.

In a further development, the drive module unit comprises an electrically driven drive unit, in particular with a rotor, which, when installed on the aircraft fuselage, is supplied with electrical energy via an electrical interface at the further coupling point. Alternatively or additionally, the drive module unit comprises a tail unit and/or a wing unit.

The further coupling point may include an information interface to provide information relating to the drive module unit, in particular with respect to the aircraft to be configured by the drive module unit. In particular, the drive module unit may comprise a storage medium which stores information relating to the drive module unit and which can be read out by the control unit via the information interface. The information stored on the storage medium may indicate a type of aircraft of the aircraft to be formed by the aircraft fuselage and the drive module unit determined by the drive module unit. Furthermore information on operating modes of the aircraft can be stored on it to ensure improved maneuvering of the aircraft by the control unit. In this way, drive module units can be attached to the aircraft fuselage according to the “plug and play” principle.

Below, embodiments are described on the basis of the figures. Identical, similar or equivalent elements are marked with identical reference signs, and a repeated description of these elements is partly omitted in the following description in order to avoid redundancies.

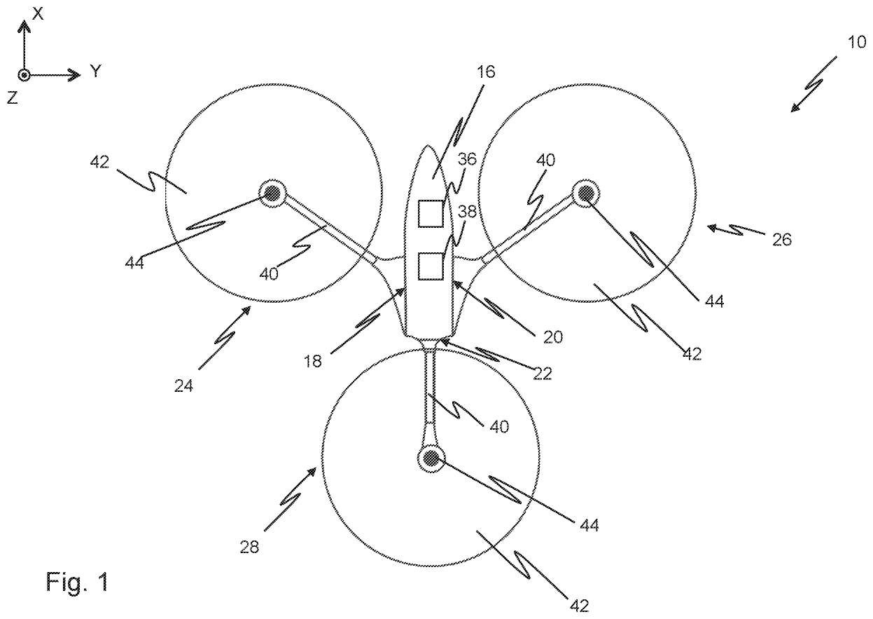

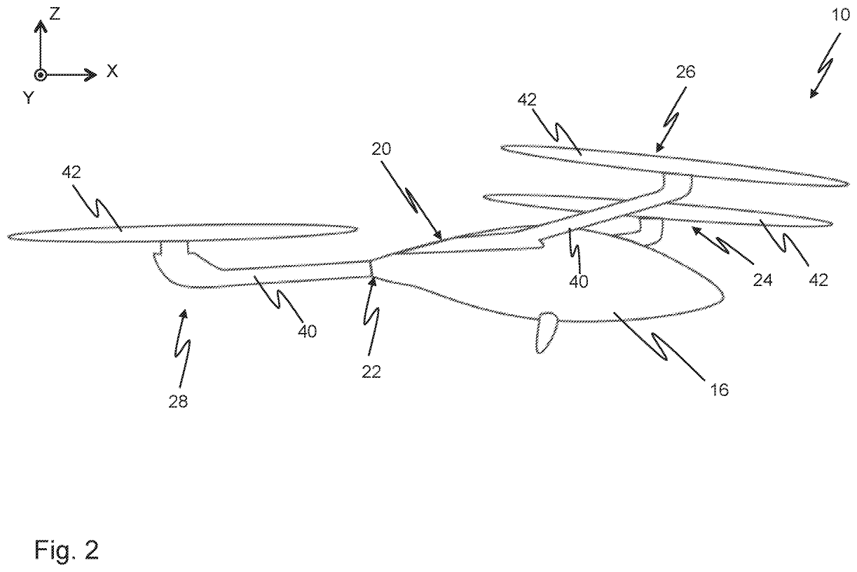

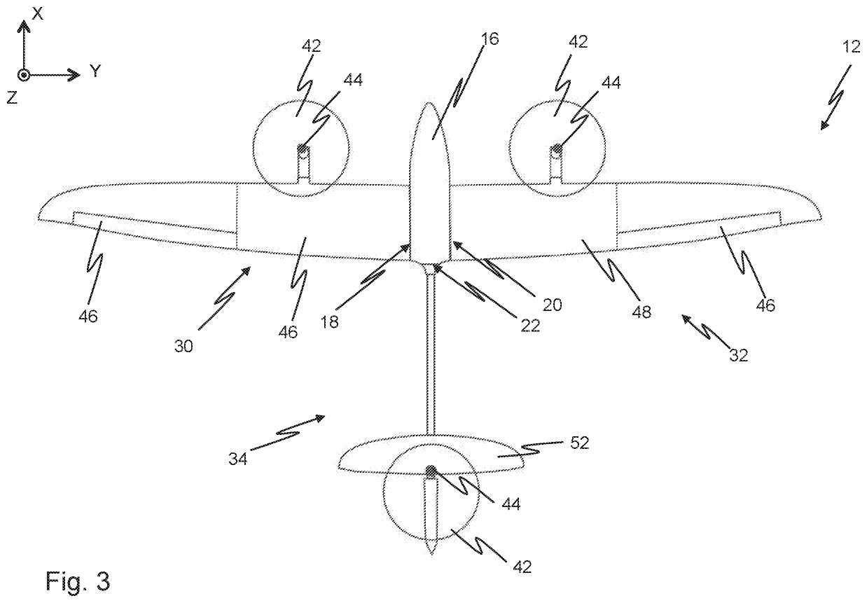

FIGS. 1 to 6 show an example aircraft system, in particular an unmanned aircraft system or drone system, for forming a first aircraft 10 shown in FIGS. 1 and 2 and for forming a second aircraft 12 shown in FIGS. 3 to 6. The first and second aircraft 10, 12 are each an UAV (Unmanned Aerial Vehicle), a drone and/or a UAS (Unmanned Aerial System).

The aircraft system comprises an aircraft fuselage 16 with three coupling points 18, 20, 22, each of which is configured to detachably and load-transmittingly connect various mutually exchangeable drive module units to the aircraft fuselage 16. More precisely, a first and a second coupling point 18, 20 are arranged along a transverse axis Y on opposite sides of the aircraft fuselage 16. A third coupling point 22 is located at the rear part of the aircraft fuselage 16 relative to a flight direction.

In a version not shown in the figures, four coupling points are provided.

In order to form the first aircraft 10 shown in FIGS. 1 and 2, the aircraft system comprises three first drive module units 24, 26, 28 which are detachably, load-transmitting and with another drive module unit interchangeably attachable to each of the three coupling points 18, 20, 22. Each first drive module unit 24-28 is assigned to exactly one of the three coupling points 18-22 and can be attached to it. In other words, the first drive module units 24-28 cannot be attached to those coupling points 18-22 which are not assigned to them. In the condition shown in FIGS. 1 and 2, in which the first drive module units 24-28 are attached to the corresponding couplings 18-22, the first aircraft 10 is formed by the aircraft system. The first drive module units 24-28 form a first set of drive module units.

In order to form the second aircraft 12 shown in FIGS. 3 to 6, the aircraft system further comprises three second drive module units 30, 32, 34 which are detachably, load-transmitting and with another drive module unit interchangeably attachable to each of the three coupling points 18, 20, 22. Every second drive module unit 30-34 is assigned to exactly one of the three coupling points 18-22 and can be attached to it. In other words, the second drive module units 30-34 cannot be attached to those coupling points 18-22 which are not assigned to them. In the condition shown in FIGS. 3 to 6, in which the second drive module units 30-34 are attached to the corresponding coupling points 18-22, the second aircraft 12 is formed by the aircraft system. The second drive module units 30-34 form a second set of drive module units.

The aircraft system is provided such that the first aircraft 10 and the second aircraft 12 are different aircraft types. More precisely, the first aircraft 10 is provided in the form of a rotary wing aircraft and the second aircraft 12 in the form of a convertible aircraft, for example with VTOL characteristics. Alternatively, one of the aircraft 10, 12 may be provided in the form of a fixed-wing aircraft.

In the first and the second aircraft 10, 12 the same aircraft fuselage 16 is used. The aircraft fuselage 16 comprises a control unit 36 for controlling the respective drive module units 24-34 attached to the aircraft fuselage 16 via coupling points 18-22 and thus for controlling the aircraft 10, 12 formed by the aircraft fuselage 16 and the drive module units 24-34 attached thereto. For this, the coupling points 18-22 each comprise a control interface for transmitting control signals to the respective drive module unit 24-34 attached thereto. The control interface is preferably an electrical interface via which electrical control signals are transmitted.

The control unit 36 is configured to control an aircraft 10, 12 formed by the aircraft fuselage 16 and the attached set of drive module unit 10, 12 in different operating modes depending on the aircraft type. In order to ensure this, at least one of the three coupling points 18-24 comprises an information interface intended for determining information relating to the set of drive module units, in particular with regard to the type of aircraft of the aircraft formed by the set 10,12. The control unit 36 is configured, on the basis of the information determined via the interface, to determine the aircraft, in particular its aircraft type, in order to control the aircraft in proper operating modes. In other words, the control unit 36 is configured to control the aircraft 10, 12, formed by the aircraft fuselage 16 and the set of drive module units 24-34 attached thereto, in different modes of operation depending on the information obtained via the information interface. For this purpose, the control unit 36 may be configured to read a storage medium arranged in a drive module unit attached to the aircraft fuselage 16 via the information interface in order to determine the corresponding information about the aircraft and its aircraft type. In this way, the control unit 36 can also read information from the storage medium about the operating modes of the aircraft and/or about optimum operating points of the aircraft.

The aircraft fuselage 16 further comprises an electrical energy storage device 38 for supplying electrical energy to the 24-34 drive module units attached to the aircraft fuselage 16 via coupling points 18-22. For this purpose, the coupling points 18-22 include an electrical interface via which electrical energy can be supplied to the drive module units 24-34 attached to it.

In the following, with reference to FIGS. 1 and 2, the design of the first drive module units 24-28 forming the first set is described in more detail. Each of the first drive module units 24-28 comprises a support structure 40 in the form of an arm or a boom, wherein a first end of the support structure 40 is provided with an interface complementary to the respective coupling point 18-22. At an end opposite the first end, the support structure 40 carries a drive unit comprising a rotor 42 and an electric motor 44 driving the rotor 42. According to this configuration, the first aircraft 10 is provided in the form of a tricopter.

The exact function and control of the drive units for maneuvering the first aircraft 10 in the form of a tricopter is known to the skilled person and will therefore not be explained here.

In the following, with reference to FIGS. 3 to 6, the design of the second drive module units 30-34 forming the second set is described in more detail. In the second aircraft 12, the drive module units 30, 32 mounted at the first and second coupling points 18, 20 differ from the drive module unit 34 mounted at the third coupling point 34.

The drive module units 30, 32 attached to the first and second coupling points 18, 20, are provided with a support structure in the form of wing unit 48 provided with a pitch elevator 46. A drive unit comprising a rotor 42 and an electric motor 44 driving the rotor 42 is arranged in the region of an inner third of the wing unit 48 with respect to its lateral extent. The moment of inertia of the second aircraft 12 can be reduced by the relatively centered located arrangement of the drive unit on the wing unit 48.

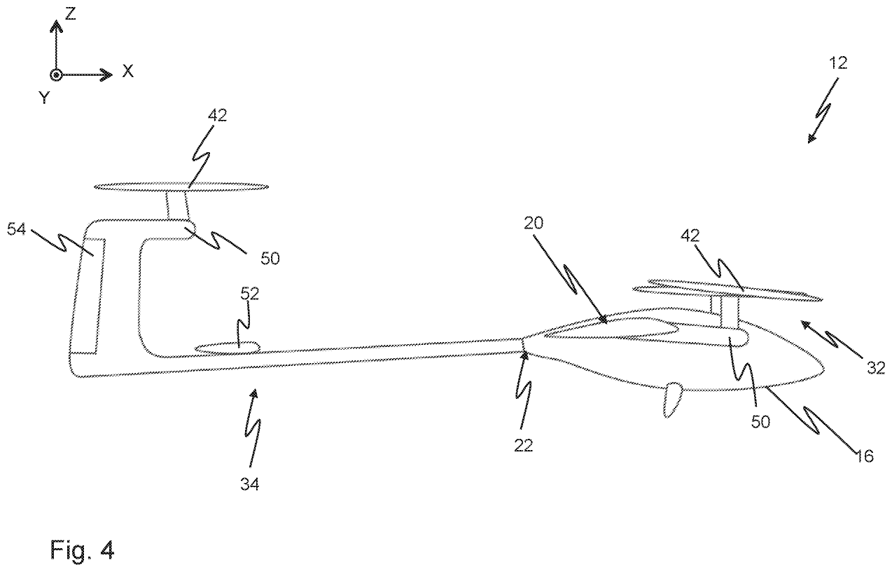

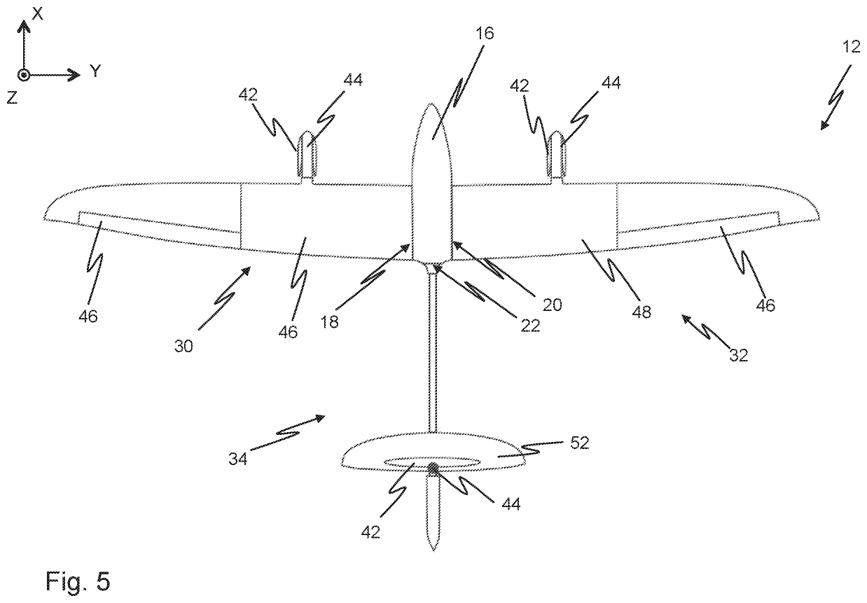

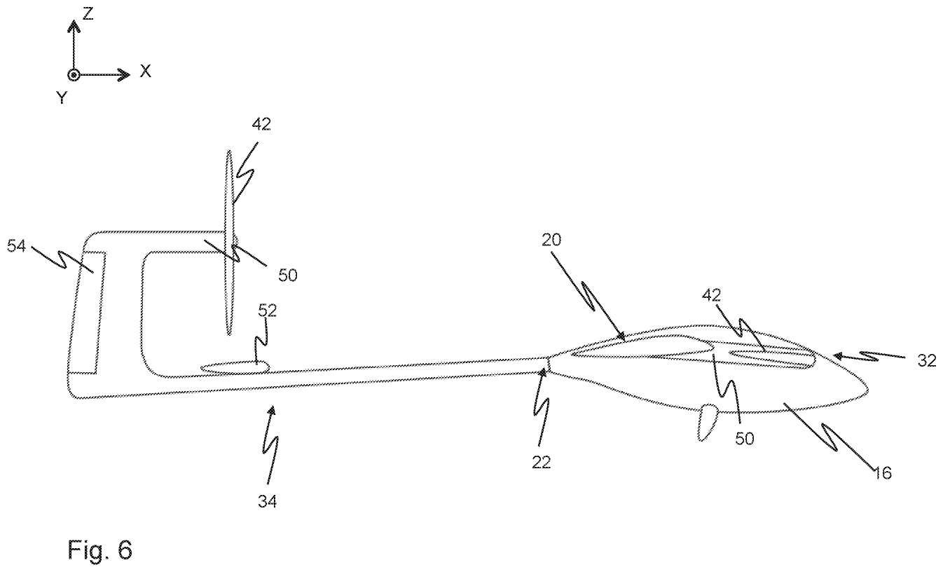

More precisely, the respective drive unit is attached to the respective wing unit 48 via a swivel mechanism 50, whereby the rotor 42 can be swiveled between a first position shown in FIGS. 3 and 4, in which the rotor 42 rotates about a vertical axis Z, and a second position shown in FIGS. 5 and 6, in which the rotor 42 rotates about a longitudinal axis X.

The drive module unit 34 attached to the third coupling point 18, 20 comprises a support structure in form of a boom with a first end adjacent the third coupling point and an opposite second end at which a tail unit with a pitch elevator and rudder 52, 54 is arranged. At the upper end of the rudder 54, the drive module unit 34 comprises a drive unit comprising a rotor 42 and an electric motor 44 driving the rotor 42. Also here, the drive unit is attached to the rudder 54 via a pivot mechanism 50, whereby the rotor 42 can be pivoted between a first position shown in FIGS. 3 and 4 in which the rotor 42 rotates about the vertical axis Z and a second position shown in FIGS. 5 and 6 in which the rotor 42 rotates about the longitudinal axis X.

In the first position of the rotors 42, the second aircraft 12 can be operated in a hover flight, for example to take off or land vertically. In this position the rotors 42 generate a vertical upward thrust. In the second position of the rotors 42, the second aircraft 12 can be operated in a horizontal flight, in which it flies in a flight mode comparable to a fixed-wing aircraft. In this position the rotors 42 generate a horizontal forward thrust. For the transition from the hovering flight to the horizontal flight, the rotors 42 can be swiveled step by step from the first to the second position during flight operation.

In accordance with this embodiment, the second aircraft 12 is provided in the form of a convertiplane. The exact function and control of the drive units for maneuvering the second aircraft 12 in the form of a convertiplane is known to the skilled person and will therefore not be explained in more detail here.

As shown in FIGS. 5 and 6, the two front rotors 42 are foldable, as the power required for the horizontal flight is significantly lower than for the hovering flight. The power required for the forward flight is only about 5% of the power required for the hovering flight. Folding in the front rotors 42 improves the aerodynamic characteristics during forward flight.

In this way both the hovering position shown in FIGS. 3 and 4, which results in a stable hovering platform, and a highly efficient dynamic flying in the position shown in FIGS. 5 and 6 can be achieved.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

As far as applicable, all the individual features presented in the individual embodiments can be combined and/or exchanged without leaving the scope of the invention.

1. An aircraft system comprising:
an aircraft fuselage having at least one coupling point that is configured to connect various mutually exchangeable drive module units detachably and load-transmittingly to the aircraft fuselage;
at least one first drive module unit that is detachably, load-transmittingly and with another drive module unit exchangeably attachable to the at least one coupling point to form a first aircraft comprising the aircraft fuselage and the first drive module unit; and
at least one second drive module unit that is detachably, load-transmittingly and with another drive module unit exchangeably attachable to the at least one coupling point to form a second aircraft comprising the aircraft fuselage and the second drive module unit,
wherein the first aircraft is a rotary wing aircraft and the second aircraft is a fixed-wing aircraft or a convertiplane.

2. The aircraft system according to claim 1, wherein at least one of the first or the second drive module units comprises at least one of: a wing unit or a tail unit.

3. The aircraft system according to claim 2, wherein
the aircraft fuselage comprises at least two coupling points, and
the aircraft system comprises:
a first set of drive module units comprising at least two first drive module units; and
a second set of drive module units comprising at least two second drive module units.

4. The aircraft system according to claim 1, wherein
the aircraft fuselage comprises at least two coupling points, and
the aircraft system comprises:
a plurality of first drive module units that include the at least one first drive module unit; and
a plurality of second drive module units that include the at least one second drive module unit.

5. The aircraft system according to claim 4, wherein each of the coupling points provided on the aircraft fuselage are connected to corresponding one of the plurality of second drive module units to form the second aircraft, and at least one of the coupling points is not connected to a drive module unit to form the first aircraft.

6. The aircraft system according to claim 1, wherein the aircraft fuselage further comprises a second coupling point that is configured to connect various mutually exchangeable drive module units detachably and load-transmittingly to the aircraft fuselage, the at least one coupling point and the second coupling point arranged along a transverse axis on opposite sides of the aircraft fuselage.

7. The aircraft system according to claim 6, wherein the aircraft fuselage further comprises a third coupling point that is configured to connect various mutually exchangeable drive module units detachably and load-transmittingly to the aircraft fuselage, the third coupling point arranged at a rear portion of the aircraft fuselage relative to a flight direction of the aircraft system.

8. The aircraft system according to claim 1, wherein the aircraft fuselage further comprises a control unit for controlling the one of the first drive module unit or the second drive module unit that is attached to the aircraft fuselage via the coupling point, wherein the coupling point comprises a control interface for transmitting control signals to the one of the first drive module unit or the second drive module unit that is attached to the aircraft fuselage via the coupling point.

9. The aircraft system according to claim 8, wherein the control unit is configured to control an aircraft formed by the aircraft fuselage and the one of the first drive module unit or the second drive module unit that is attached to the aircraft fuselage via the coupling point in an operating mode of a plurality of operating modes, the operating mode selected of a plurality of operating modes based on the one of the first drive module unit or the second drive module unit that is attached to the aircraft fuselage via the coupling point.

10. The aircraft system according to claim 9, wherein the coupling point comprises an information interface to obtain information relating to the one of the first drive module unit or the second drive module unit that is attached to the coupling point with regard to an aircraft type predetermined by the one of the first drive module unit or the second drive module unit that is attached to the coupling point, wherein the control unit controls the aircraft formed by the aircraft fuselage and the one of the first drive module unit or the second drive module unit that is attached to the coupling point in different operating modes depending on the information obtained via the information interface.

11. The aircraft system according to claim 1, wherein the aircraft fuselage further comprises an electrical energy storage for supplying the one of the first drive module unit or the second drive module unit that is attached to the aircraft fuselage via the coupling point with electrical energy, wherein the at least one coupling point comprises an electrical interface via which electrical energy can be supplied to the one of the first drive module unit or the second drive module unit that is attached to the coupling point.

12. The aircraft system according to claim 1, wherein one of the first drive module unit or the second drive module unit comprises:
at least one further coupling point which is complementary to the at least one coupling point of the aircraft fuselage and which is configured to connect the one of the first drive module unit or the second drive module unit detachably and load-transmittingly to the aircraft fuselage, wherein the further coupling point comprises an information interface for providing information relating to the one of the first drive module unit or the second drive module unit; and
a storage medium which stores information relating to an aircraft type to be formed by the one of the first drive module unit or the second drive module unit, wherein the information is readable out by a control unit of the aircraft fuselage via the information interface.

13. The aircraft system according to claim 1, wherein one of the first drive module unit or the second drive module unit comprises at least one of: a wing unit, a tail unit, and at least one electrically driven drive unit.

14. An aircraft fuselage for an aircraft system, the aircraft fuselage comprising:
at least one coupling point that is configured to detachably and load-transmittingly connect various mutually exchangeable drive module units to the aircraft fuselage to form aircrafts of different aircraft types depending on a drive module unit to be attached to the coupling point,
wherein the coupling point is configured to:
detachably, load-transmittingly and with another drive module unit exchangeably attach at least one first drive module unit to the aircraft fuselage to form a first aircraft in the form of a rotary wing aircraft, and
detachably, load-transmittingly and with another drive module unit exchangeably attach at least one second drive module unit to the aircraft fuselage to form a second aircraft in the form of a fixed-wing aircraft or a convertiplane.

15. The aircraft fuselage according to claim 14, further comprising a second coupling point that is configured to connect various mutually exchangeable drive module units detachably and load-transmittingly to the aircraft fuselage, the at least one coupling point and the second coupling point arranged along a transverse axis on opposite sides of the aircraft fuselage.

16. The aircraft fuselage according to claim 15, further comprising a third coupling point that is configured to connect various mutually exchangeable drive module units detachably and load-transmittingly to the aircraft fuselage, the third coupling point arranged at a rear portion of the aircraft fuselage relative to a flight direction of the aircraft system.

17. The aircraft fuselage according to claim 14, further comprising a control unit for controlling the one of the first drive module unit or the second drive module unit that is attached to the aircraft fuselage via the coupling point, wherein the coupling point comprises a control interface for transmitting control signals to the one of the first drive module unit or the second drive module unit that is attached to the aircraft fuselage via the coupling point.

18. The aircraft fuselage according to claim 17, wherein the control unit is configured to control an aircraft formed by the aircraft fuselage and the one of the first drive module unit or the second drive module unit that is attached to the aircraft fuselage via the coupling point in different operating modes, the operating mode selected depending on the one of the first drive module unit or the second drive module unit that is attached to the aircraft fuselage via the coupling point.

19. The aircraft fuselage according to claim 18, wherein the coupling point comprises an information interface to obtain information relating to the one of the first drive module unit or the second drive module unit that is attached to the coupling point with regard to an aircraft type predetermined by the one of the first drive module unit or the second drive module unit that is attached to the coupling point, wherein the control unit controls the aircraft formed by the aircraft fuselage and the one of the first drive module unit or the second drive module unit that is attached to the coupling point in different operating modes depending on the information obtained via the information interface.

20. The aircraft fuselage according to claim 14, further comprising an electrical energy storage for supplying the one of the first drive module unit or the second drive module unit that is attached to the aircraft fuselage via the coupling point with electrical energy, wherein the at least one coupling point comprises an electrical interface via which electrical energy can be supplied to the one of the first drive module unit or the second drive module unit that is attached to the coupling point.
